(19) United States
(12) Patent Application Publication
(10) Pub. No.: US 2026/0170180 A1
(43) Pub. Date: Jun. 18, 2026

(54) Systems and Methods for Validating the Integrity of OT and ICS Backups Using Generative AI, Agentic AI, and Sandboxed Analysis

(71) Applicant: Savlador Technologies LTD, Rehovot (IL)

(72) Inventors: Oleg Vusiker, Petach Tikva (IL); Alex Yevtushenko, Kiryat Gat (IL); Amit Hammer, Herzeliya (IL)

(21) Appl. No.: 19/334,874

(22) Filed: Sep. 21, 2025

Related U.S. Application Data
(60) Provisional application No. 63/735,330, filed on Dec. 18, 2024.

(51) Int. Cl. G06F 21/64; G06F 11/14; G06F 21/53

(52) U.S. Cl. CPC G06F 21/64; G06F 11/1448; G06F 21/53; G06F 2201/805; G06F 2221/033

(57) ABSTRACT

Systems and methods are disclosed for validating the integrity of backups in operational technology (OT) and industrial control system (ICS) environments. A metadata collector extracts security-relevant and operational attributes from backup images in intrusive, nonintrusive, or offline modes. The extracted metadata is normalized into a canonical schema and analyzed by a generative artificial intelligence (GenAI) engine that computes an integrity risk score based on differences from a golden image baseline, threat intelligence, and policy. Optionally, the backup is executed in an isolated sandbox to validate recoverability and observe runtime behavior. The system generates tamper-evident reports containing compliance-aligned evidence and restoration guidance. Designed for environments with low bandwidth, air gaps, or unidirectional gateways, the system supports regulatory frameworks such as IEC 62443 and NERC CIP, enabling high-confidence, auditable validation of backup safety across ICS assets without disrupting production systems.

### BACKGROUND OF THE INVENTION

### Field of Invention

The present invention relates generally to the field of industrial cybersecurity, and more particularly to systems and methods for ensuring the integrity, safety, and recoverability of backup data in operational technology (OT) and industrial control system (ICS) environments. Specifically, the invention pertains to backup verification platforms that utilize compact metadata extraction, generative and agentic artificial intelligence (AI), and sandboxed virtual environments to analyze, validate, and audit backup artifacts in compliance with industrial standards such as IEC 62443, NERC CIP, and related frameworks.

### BRIEF SUMMARY OF THE INVENTION

The invention provides systems and methods for verifying the integrity of backups created in OT and ICS networks prior to restoration. A collector component operates in multiple modes, including intrusive post-backup execution, nonintrusive sandbox analysis, and offline snapshot parsing, to extract compact, structured metadata describing files, drivers, processes, services, ICS project configurations, and security controls.

The collected metadata is transmitted across outbound-only paths, e.g., via firewalls, data diodes, or unidirectional gateways, to an AI-driven analysis service. This service employs generative or agentic AI models, optionally fine-tuned on industrial threat data, to detect anomalies, correlate metadata against golden images, and compute an Integrity Risk Score. The analysis engine further generates compliance-aligned reports with remediation guidance and audit artifacts.

Optionally, the platform can instantiate a virtual machine from the backup in a sandboxed environment to confirm successful system boot, evaluate service liveness, detect dormant malware through detonation, and perform patch or recovery testing—all without impacting production systems. The platform also integrates forensic-grade logging, policy-driven baseline management, and metadata normalization to support fleet-wide backup visibility and regulatory compliance.

These mechanisms collectively address the growing need for secure, explainable, and tamper-evident backup integrity validation in critical infrastructure environments where bandwidth constraints, unidirectional connectivity, and legacy systems preclude the use of traditional IT security solutions.

### BRIEF DESCRIPTION OF THE FIGURES

FIG. 1: Illustrates the architecture of the metadata collection and GenAI analysis workflow for backup integrity verification in OT/ICS environments.

FIG. 2: Depicts a sandbox-based backup verification system where a backup is executed in isolation and analyzed by an integrity verifier AI agent.

FIG. 3: Shows an offline backup metadata extraction process that enables static analysis without executing the backup image.

FIG. 4: Provides examples of hierarchical integrity reports at the asset, site, and enterprise levels for compliance and risk aggregation.

FIG. 5: Demonstrates a JSON metadata record showing system information, detected processes, network activity, USB events, and backup status.

FIG. 6: Illustrates the detection of unauthorized PLC communications via Python and executable artifacts through GenAI analysis of ICS metadata.

FIG. 7: Depicts a backup failure record showing non-compliance with IEC 62443 due to an integrity check failure.

FIG. 8: Shows detection of Stuxnet-style DLL injection based on anomalous files discovered during golden image differencing.

FIG. 9: Illustrates detection of ESET AV/EDR termination through a BYOVD (Bring Your Own Vulnerable Driver) attack using telemetry metadata.

### DETAILED DESCRIPTION

In accordance with various embodiments of the present invention, disclosed herein are systems and methods for ensuring backup integrity in Operational Technology (OT) and Industrial Control System (ICS) environments through a modular, scalable, and OT-compliant architecture. The invention provides a unified platform that integrates secure backup collection, metadata transformation, artificial intelligence-based integrity assessment, and optional sandbox validation into an end-to-end system capable of deployment across cloud, on-premises, or hybrid infrastructures.

The disclosed architecture comprises a plurality of operational nodes and data flow pipelines specifically designed to accommodate the unique constraints of OT networks, including low-bandwidth connectivity, unidirectional data paths, legacy system compatibility, and a general intolerance for persistent agents or invasive runtime operations. The core components include (i) one or more backup sources, including but not limited to human-machine interfaces (HMIs), engineering workstations, historians, domain controllers, and programmable logic controller (PLC) project file repositories; (ii) a metadata collector module operable in multiple modes; (iii) an analysis and orchestration backend comprising Generative and agentic artificial intelligence models; (iv) an optional sandbox execution subsystem; and (v) a reporting and visualization layer capable of generating forensic-grade artifacts and compliance-ready summaries.

The metadata collector may be deployed in any of three mutually exclusive modes, each designed to respect the operational sensitivity and architectural limitations of ICS environments. In the Post-Backup Intrusive Mode, the collector is executed directly on the production host shortly after the successful completion of a backup operation. The collector operates under tight runtime and resource constraints, extracting a predefined set of artifacts—including file inventories, driver states, service configurations, scheduled tasks, registry entries, and ICS-specific project elements—and subsequently terminates. In certain embodiments, the collector is invoked by a trigger mechanism such as a scheduled task, policy-controlled script, or orchestration engine directive, and may self-delete upon successful data emission. The emitted metadata is compact, cryptographically signed, and suitable for outbound-only transmission.

In the Nonintrusive Sandbox Mode, the collector is introduced into a virtual machine instantiated from the backup artifact itself. The backup image is booted in a fully isolated environment, either on-premises or in a cloud hypervisor, without network connectivity to production assets. The collector runs within the context of the sandboxed environment, capturing both static system state and dynamic runtime telemetry such as process launches, network communications, driver loads, and service behavior. This mode provides significant forensic advantages by emulating a live restoration while ensuring no interaction with actual OT networks. The sandbox may be further configured with temporary administrative credentials, pre-injected drivers, or read-only storage overlays to support specific boot or inspection requirements.

In the Offline Snapshot Analysis Mode, the collector operates against a backup image mounted in read-only form. This static analysis mode requires no execution of the backup image and is thus particularly suitable for air-gapped environments or repositories employing write-once-read-many (WORM) storage or object-lock retention. The collector parses the file system, registry hives, event logs, and ICS project files directly from the mounted image, producing a normalized metadata payload analogous to that generated in other modes. This mode enables automated integrity analysis at scale.

All three operational modes might enforce outbound-only data movement and emit compact metadata packets that exclude process values, operational commands, or sensitive control logic. In preferred embodiments, the metadata is transmitted over a demilitarized zone (DMZ) network segment using a unidirectional gateway, data diode, or firewall-enforced route that disallows any inbound connectivity. This design ensures full compliance with OT segmentation policies and prevents the introduction of lateral threats into critical environments.

The collected metadata is transmitted to a centralized or distributed backend for normalization and analysis. In various embodiments, this backend includes a secure processing pipeline that prepares the data for ingestion by Generative AI or agentic AI components and links each capture to a backup identifier, asset profile, and optionally, a site or enterprise-level taxonomy. The backend may operate in a cloud-based environment (public or private), within a corporate IT enclave, or on-premises on specialized hardware such as a GPU node or SmartNIC/DPU, depending on deployment preferences and compliance constraints.

The modular design of the system allows seamless adaptation to differing plant architectures, including those with segmented trust domains, air-gapped SCADA networks, and bandwidth-limited field sites. Furthermore, the platform's adherence to the principles of least privilege, zero trust, and immutability ensures that each component operates in a manner consistent with prevailing cybersecurity and safety standards across industrial sectors.

The present invention discloses a comprehensive metadata normalization and comparison framework configured to support scalable, accurate, and explainable assessment of backup integrity within OT and ICS environments. Recognizing the extreme heterogeneity of artifacts present in such systems—including vendor-specific PLC and DCS project files, firmware packages, engineering tool outputs, registry entries, and conventional operating system elements—the invention introduces a canonical schema that expresses system state in a structured, format-agnostic manner suitable for downstream analysis, forensic reporting, and regulatory compliance.

In various embodiments, upon collection from any of the three supported operational modes (post-backup, sandbox, or offline snapshot), raw telemetry is converted into a set of standardized record types. These records may include, without limitation, EXEFileRecord, DLLFileRecord, DriverRecord, ServiceRecord, RegistryEntryRecord, USBEventRecord, ICSArtifact, PLCProjectFileRecord, and OSInfoRecord. Each record is populated with metadata fields such as file paths, cryptographic hashes, digital signatures, file entropy, timestamps, signer identities, kernel hooks, and other attributes indicative of system provenance, configuration, or behavioral state. In preferred embodiments, metadata is serialized into one or more structured formats, such as JSON, CSV, CBOR, Protobuf, or Avro, and is optionally compressed, encrypted, or bandwidth-throttled prior to egress.

Central to the platform's capability is the establishment and ongoing governance of golden image baselines. A golden image baseline comprises a canonical representation of a known good system state for a particular asset, device class, or deployment profile. This representation includes a full enumeration of validated configurations across files, services, drivers, registry keys, and ICS-specific control artifacts. The baseline is uniquely identified by a baselineId, which might digitally signed, and timestamped (baselineGenerationTime) to provide traceable lineage. In some embodiments, the baseline is stored in an immutable repository—such as a cloud object store configured with object lock (e.g., AWS S3 Object Lock), a WORM array, or append-only file system—with cryptographic safeguards against unauthorized modification or deletion.

The baseline creation process may be orchestrated manually or automatically, contingent upon policy controls, and is typically invoked during maintenance windows, post-commissioning events, or controlled reconfiguration cycles. To ensure accuracy and repeatability, the collector is executed in “baseline mode,” which may be triggered by a command-line argument, API flag, or orchestration parameter, and which causes the collector to perform full canonical data acquisition without delta suppression or exclusion filtering. The resulting baseline metadata may be locally cached to enable offline differencing in sites that lack real-time cloud or inter-zone (LAN) connectivity.

Once a baseline has been established, all subsequent metadata captures are subject to differential analysis. During differential mode execution, the collector or backend processing pipeline computes a structured delta between the new backup and the referenced baseline. This DiffFromGoldenImage artifact captures additive, subtractive, and modified elements across each record type. Key fields include filesAdded, filesModified, filesDeleted, driverChanges, exeChanges, dllChanges, pyChanges, serviceChanges, registryChanges, and icsProjectDiff. Delta records may also contain computed metrics such as percentSystemChanged, entropy deltas, risk deltas, and anomaly scores, and may further highlight high-sensitivity changes, such as unsigned or previously unseen binaries, protection disablement (e.g. AV/EDR disablement), or changes to safety-critical firmware targets.

To optimize bandwidth and analyst focus, the delta computation engine applies a configurable set of policy-based suppression and prioritization rules. For example, changes within approved maintenance windows may be annotated with an expectedChange flag, while new processes that match known benign hashes or vendor toolchains may be excluded from high-sensitivity analysis. Conversely, anomalous or contextually inappropriate modifications—such as a malicious PLC project file targeting a controller—are prioritized and surfaced explicitly in downstream integrity scoring.

In some embodiments, a PLC/DCS project tracker operating as a backup centric configuration change management system for industrial control environments is provided. The system captures and normalizes delta artifacts as part of scheduled or event driven backups of control system assets, including PLC/DCS project files, HMI and SCADA projects, file system objects, registry entries, and networked parameter sets; a cross vendor backup repository maintains versions across formats such as Siemens STEP 7 .s7p, Siemens TIA Portal .apXX and .zapXX, and Schneider Electric EcoStruxure Control Expert .STU, .STA, .XEF, and .ZEF.PLC/DCS project files are the authoritative source for PLC/DCS control and plant operation, encapsulating executable logic (ladder logic, function blocks, Structured Text), I/O and signal scaling, tag databases, setpoints and limits, safety interlocks and permissions, alarm definitions, network addresses and routing, and controller to HMI bindings; accordingly, manipulation or accidental misconfiguration can, among other effects, bypass interlocks, inhibit alarms, apply incorrect setpoints or units, swap I/O channels, break communications, trigger unauthorized actuation, degrade product quality, cause loss of view or control, extend downtime, or create safety, environmental, or regulatory exposure. Within each backup set, the system writes metadata that annotates detected deltas with compliance relevant indicators mapped to IEC 62443 3 3, IEC 62443 2 1 CM 1.4 change control, and NERC CIP 010; this metadata, together with available exported PLC/DCS logic, serves as input to a generative artificial intelligence model fine-tuned using parameter efficient techniques, for example Low Rank Adaptation, lightweight adapters, or instruction and prompt tuning, with adapters selected per detected PLC/DCS family and project format. The model generates reports that include semantic diffs, risk scores, compliance mapping, and deterministic evidence based recommendations to restore from the backups to an approved last known good snapshot, and the reports are stored with the corresponding backup set to provide machine verifiable audit evidence of governed configuration. The differential analysis pipeline is capable of scaling across tens to thousands of assets by virtue of its design emphasis on compact, structured metadata and the inherent immutability and traceability of golden image references. Furthermore, by abstracting asset state into canonical forms and expressing differences as deterministic, explainable artifacts, the platform eliminates reliance on subjective or heuristic-based judgment and enables reproducible, tamper-evident assessments across the enterprise.

This metadata normalization and differential comparison framework equips OT/ICS operators with the means to continuously monitor, validate, and audit backup integrity without imposing operational overhead, and while maintaining strict separation between collection domains and analysis zones.

The present invention further comprises an advanced integrity evaluation subsystem centered on Generative Artificial Intelligence (GenAI) and agentic AI constructs, each operable as first-class analytical components within the platform. These AI systems are expressly configured to assess the trustworthiness of backup artifacts collected from OT and ICS environments, where conventional IT-centric tools are often ineffective due to segmentation boundaries, protocol divergence, and safety-critical operational constraints. The GenAI component is trained to ingest structured metadata derived from one or more operational modes—namely, post-backup collection, sandbox execution, or offline snapshot analysis—and to reason over such inputs in order to compute both qualitative and quantitative determinations of backup integrity.

Upon receipt of the normalized metadata, which includes file inventories, executable properties, driver and service configurations, registry entries, USB event logs, and industrial control project artifacts, the GenAI engine performs a schema validation and initiates a sequence of differencing and threat inference operations. This includes comparing the incoming records against a corresponding golden image baseline, detecting unauthorized deltas, assigning semantic annotations to anomalous changes, and evaluating the delta in light of known threat patterns and industrial-specific attack indicators. In preferred embodiments, the GenAI model is pre-trained and optionally fine-tuned using adapter-based methods such as LoRA (Low-Rank Adaptation) on labeled datasets comprising historical OT-specific incidents, including but not limited to attacks modeled after Stuxnet, Industroyer, Shamoon, Triton, and other nation-state-level ICS campaigns.

The analytical outcome of this process is the computation of an Integrity Risk Score, which encapsulates a numerical valuation of backup trustworthiness together with an interpretive rationale that details contributing anomalies, matched threat patterns, unsigned or vulnerable binaries, configuration drifts, suspicious autoruns, and any deviations from the known-good system state. This score is not merely a heuristic but is instead derived from a series of explainable inference steps, each of which is logged, reproducible, and mappable to technical controls defined in industrial cybersecurity frameworks such as IEC 62443-3-3, NERC CIP-010, and NIST SP 800-82. In certain embodiments, each GenAI invocation results in the generation of a tamper-evident integrity report, cryptographically signed and format-aligned to versioned templates that support structured exports, including JSON, PDF, CSV, or machine-ingestible compliance bundles.

In addition to the core GenAI engine, the platform may invoke one or more agentic AI processes—referred to herein as policy-constrained autonomous agents—that operate on defined scopes under strict least-privilege principles. These agents are configured to enhance the core analysis by performing auxiliary evaluations or initiating targeted subprocesses where uncertainty, risk, or compliance requirements so dictate. For example, an integrity-verification agent may autonomously initiate a one-time sandbox boot and controlled detonation sequence for binaries flagged as suspicious but lacking known threat classifications. The results of such sandbox executions are then incorporated back into the GenAI inference pipeline to refine the integrity assessment. In another embodiment, a recovery orchestration agent may evaluate the integrity and risk distribution across a plurality of backups associated with a single asset or site and propose an optimal restoration sequence based on bandwidth constraints, interdependencies, integrity scores, and recovery time objectives.

Further extending the intelligence layer, a compliance-monitoring agent may persistently monitor backup job success metrics and retention schedules, flagging failed or missed backups as compliance deviations. This agent is equipped with regulatory knowledge mapping capabilities, enabling it to correlate operational lapses with the relevant clauses in applicable frameworks, such as the 15-month recovery test requirement of NERC CIP-009. Additionally, a scheduling optimization agent may analyze CPU, network, and user activity telemetry to identify low-impact windows during which backups may safely be executed without disrupting HMI or PLC operations, thereby aligning operational continuity with backup reliability.

The invention further contemplates optional integration with third-party threat intelligence services, accessible through policy-restricted, outbound-only interfaces. These services may receive non-sensitive indicators, such as file hashes or behavioral summaries, and return consolidated intelligence verdicts, including malware family names, confidence scores, reputational context, and threat prevalence data. Such integrations are strictly controlled through configuration policy and administrative approval workflows, and no raw file content or plant-specific identifiers are transmitted by default. The results of these lookups are fed into the GenAI model, enhancing its ability to distinguish emergent or polymorphic threats from benign change.

From a deployment standpoint, the GenAI and agentic AI modules may execute in multiple trust domains, depending on site requirements, data sensitivity, and system architecture. In one embodiment, the AI operates entirely within a private cloud or corporate data enclave, isolated from the OT segment by a demilitarized zone and hardened firewall configurations. In another embodiment, the analysis engine is executed on a SmartNIC or Data Processing Unit (DPU), such as an NVIDIA BlueField-3, physically colocated with the backup store and operating in a zero-trust configuration. In this arrangement, the DPU maintains complete isolation from the host system, supporting execution of medium-scale generative models and providing secure AI operations in regulated or air-gapped environments.

Critically, all autonomous actions recommended or initiated by the agentic AI modules are subject to human-in-the-loop governance. No remediation step, including deletion of artifacts, restoration from prior backups, or system reconfiguration, is performed without explicit operator approval. All agent actions are fully logged and auditable, with complete telemetry records supporting regulatory transparency and post-event forensics.

Through the integration of these GenAI and agentic AI mechanisms, the present invention enables a highly contextual, low-latency, and explainable means of backup integrity verification that is uniquely tailored to the operational and regulatory realities of OT and ICS environments. The architecture empowers operators to make informed restoration decisions, prioritize remediation based on risk, and demonstrate due diligence through structured, tamper-evident outputs that satisfy both internal and external audit requirements.

In a further embodiment of the invention, the platform incorporates a secure, isolated sandbox execution environment purpose-built for validating the recoverability, functionality, and threat posture of backups without engaging or endangering production systems. This sandbox layer serves as an optional but integral part of the overall architecture, facilitating forensic-grade testing of backup artifacts in a controlled virtualized domain. The design explicitly accounts for the constraints of operational technology (OT) and industrial control systems (ICS), including air-gapped configurations, legacy system support, restricted bandwidth, and the strict prohibition of live interaction with critical infrastructure assets during verification.

The sandbox is instantiated by mounting or importing a backup image—such as a virtual hard disk (VHD, VHDX), virtual machine disk (VMDK), or other standard hypervisor-supported format—into a virtualization platform that is segregated from production networks. In preferred embodiments, the sandbox environment is hosted either in a secured on-premises hypervisor or within a tightly scoped cloud instance with no connectivity to external systems unless explicitly permitted by policy. The platform supports pre-boot preparation of the backup image to ensure compatibility with the execution environment, which may include injecting necessary device drivers (e.g., AWS EC-2 compatible NVMe storage driver or AWS EC2-compatible network interfaces), modifying registry entries to enable automatic login, or placing lightweight inspection tools at known filesystem locations.

To facilitate a forensic inspection from the earliest stages of execution, the system modifies the mounted image to insert a portable, non-persistent collector component that activates upon first boot. This collector executes only once under a one-time-use local administrator account that is provisioned at the registry level through reversible and well-documented means (e.g., temporary modifications to Winlogon, RunOnce, and SAM hives). The credentials are short-lived and expire automatically after data collection, ensuring that no residual access mechanisms remain. Upon boot, the sandboxed virtual machine initiates telemetry capture beginning at system startup, allowing the collector to record runtime behaviors including process launches, service initialization, network connections, filesystem and registry changes, and other activities that may reveal dormant or time-bomb threats embedded in the backup.

Critically, the sandboxed execution environment enforces strong isolation and tamper resistance. Network interfaces are segmented from the production OT/ICS network, unless explicitly required for behavioral analysis. Filesystem access might be configured in copy-on-write or snapshot mode, ensuring that the original backup image remains unaltered. Policy controls prevent elevation of privilege, outbound communication, or self-modification of the sandbox environment. The execution window is time-bounded, and system telemetry is captured in real time and compressed into a compact metadata structure suitable for secure transfer to the backend analysis engine. After completion, the sandbox environment is destroyed or returned to a clean state, with metadata generated to certify the collection integrity and analysis provenance.

The invention further contemplates the use of sandbox environments for virtual restoration testing, wherein the system evaluates whether a backup image can boot successfully and whether its operating system, services, and applications are initialized correctly. This is accomplished by programmatically verifying heartbeat signals (e.g., via ICMP ping or guest agent acknowledgment), examining boot logs, and capturing key runtime metrics indicative of system liveliness and readiness. The resulting validation confirms not only the syntactic integrity of the backup image but also its functional recoverability—i.e., whether the system will perform as intended if restored. In industrial contexts, this capability is particularly critical, as failure to validate restoration procedures can compromise safety systems or result in process downtime.

In some embodiments, the sandbox is further utilized for controlled detonation of suspicious binaries, scripts, or configuration elements that were identified as potentially malicious by the generative AI or differencing engine. The sandbox provides a safe execution context wherein such artifacts can be allowed to run, with real-time observation of process trees, system calls, memory allocation patterns, and network traffic. All resulting behaviors are recorded and used to augment the Integrity Risk Score assigned to the backup. This detonation capability allows for high-confidence classification of dormant threats, such as ransomware loaders, logic bombs, or adversary simulations that would otherwise evade static detection.

Another practical application of the sandbox is for pre-deployment patch testing, wherein operators may apply a software update, vendor patch, or firmware change to the sandboxed instance of the backup prior to deploying the same in production. The system then evaluates whether the patched instance remains stable, whether required services continue to start, and whether baseline operational characteristics are preserved. This technique is particularly valuable in OT/ICS domains where patch deployment windows are rare and rollback procedures are complex.

The sandbox environment is also designed to satisfy regulatory and compliance mandates, particularly those requiring periodic recovery testing and validation of restoration procedures. For example, under NERC CIP-009, regulated entities must test recovery plans at least once every 15 months. The invention supports this mandate by generating automated, tamper-evident recovery test reports, which document the backup boot status, system health at startup, and comparison to golden image baselines. These reports are signed, time-stamped, and might be stored in a forensic vault, rendering them suitable for submission during internal audits or external regulatory reviews.

Importantly, all sandbox operations are executed under strict governance and audit protocols. Each sandbox instance is tagged with a unique identifier and audit trail, including metadata such as the backup ID, baseline reference, runtime duration, and resulting disposition (e.g., “boots cleanly,” “malicious activity detected,” “missing driver,” “failed services”). This metadata is cross-linked with the GenAI and agentic AI outputs to form a composite integrity report. Furthermore, access to sandboxed environments is restricted to authenticated personnel, and all system changes during sandbox runs are logged, and preserved for later verification.

Through these mechanisms, the sandbox execution environment not only serves as a safety net for high-risk backups but also enables continuous assurance that recovery procedures will function as expected when invoked. It allows organizations to simulate and validate disaster recovery workflows, test the impact of changes in a risk-free manner, and confidently certify the integrity of backup artifacts in OT/ICS environments where real-world testing is impractical or impermissible. Accordingly, this aspect of the invention plays a central role in bridging the gap between backup existence and backup reliability in complex industrial settings.

In a further embodiment, the invention provides structured mechanisms for aligning backup integrity operations with industrial cybersecurity compliance regimes, while simultaneously supporting forensic investigation, internal governance, and sector-specific operational requirements. The system is architected to operate in strict accordance with internationally recognized cybersecurity standards, including but not limited to the IEC 62443 family of industrial automation and control system security standards, the North American Electric Reliability Corporation Critical Infrastructure Protection (NERC CIP) standards, and guidance documents such as the National Institute of Standards and Technology (NIST) Special Publication 800-82.

The system's architectural and functional design maps directly to technical and procedural objectives mandated by these standards. For example, IEC 62443-3-3 requires capabilities for backup integrity monitoring, secure backup and restoration, and controlled change management. The present invention satisfies these requirements through persistent collection and differencing of backup metadata, continuous verification against golden image baselines, structured scoring of integrity risk, and the generation of tamper-evident restoration evidence. Similarly, under NERC CIP-009, regulated entities are required to perform periodic testing of recovery plans and demonstrate that their systems can be restored from backup in a reliable manner. The sandbox subsystem disclosed herein allows virtual execution of recovery scenarios with traceable outcomes, thereby fulfilling the recovery test obligation without exposing production systems to risk.

The platform also integrates features to support audit preparation and compliance validation through the automatic generation of evidence artifacts. Each backup event, collection run, sandbox test, and AI analysis produces a corresponding report that includes timestamps, asset identifiers, integrity deltas, risk scores, and compliance-relevant observations. These artifacts are assembled into audit bundles, which may be exported in formats suitable for both human inspection and machine ingestion. The reports incorporate alignment checklists and narratives that trace findings to regulatory objectives, such as demonstrating that integrity changes were monitored and authorized, that failed or missed backups were detected and escalated, and that restoration scenarios were validated on a recurring basis.

For organizations operating across multiple sites or jurisdictions, the invention further supports enterprise-wide compliance aggregation. In some embodiments, the platform generates asset-level, site-level, and company-level reports that roll up key performance indicators (KPIs) such as average backup integrity risk, restoration test coverage, backup policy drift frequency, and compliance coverage by framework. These reports are structured to allow drill-down from high-level metrics to per-backup or per-asset records, and they retain the full provenance chain from collection through analysis. By enabling this level of structured visibility, the system permits senior leadership, compliance teams, and regulators to evaluate not only individual system readiness, but also systemic resilience across the organization.

In addition to compliance alignment, the platform demonstrates broad industrial applicability. The invention is deployable across multiple critical infrastructure sectors, including electric utilities, oil and gas, water and wastewater treatment, manufacturing, building management systems, transportation, and chemical processing. These sectors share common traits—such as reliance on legacy equipment, restricted bandwidth availability, air-gapped environments, and strict change control—which preclude traditional IT-centric security models and render conventional endpoint verification techniques infeasible. The present invention overcomes these constraints by limiting all data collection to outbound-only metadata transfers, avoiding any persistent footprint on production assets, and offering full functionality even in environments with no inbound connectivity.

The system is also designed for adaptability across varying deployment models and trust postures. It may be deployed entirely on premises within an industrial site, in a customer-controlled private cloud, or in a hybrid model wherein collection and analysis components are distributed across security domains with secure demilitarized zone (DMZ) bridging. In air-gapped or classified environments, the analysis engine may execute on a Data Processing Unit (DPU) or a hardened GPU node operating in a zero-trust configuration, with offline model updates and policy-controlled export mechanisms. This flexibility ensures that the platform can be tailored to satisfy not only operational needs but also regulatory data sovereignty, privacy, and assurance mandates.

The invention further contemplates the generation of forensic-grade outputs, including immutable logs, hash-chained records, and signed reports that satisfy chain-of-custody requirements. These artifacts are suitable for internal review, legal inquiry, or regulatory submission and are generated automatically as a byproduct of normal operation. The use of tamper-evident storage, cryptographically verifiable timestamps, and append-only repositories ensures that integrity and evidentiary quality are preserved over time. Such features are essential for satisfying the expectations of both auditors and incident response teams, particularly in high-consequence industrial domains where documentation of system state and recovery capability is paramount.

Moreover, the invention provides mechanisms for compliance scoring and gap detection that allow organizations to monitor their adherence to required practices in real time. For example, when a backup job fails to execute or a recovery test has not been performed within the regulatory time frame, the system automatically flags the affected asset as non-compliant and annotates the compliance report accordingly. These flags affect the aggregate compliance score and are visible on site-level dashboards and enterprise rollups, allowing for timely remediation. Automated notifications and system-generated remediation suggestions may be issued to responsible parties, ensuring that gaps do not persist undetected.

Finally, the invention's use of explainable AI ensures that compliance outcomes are traceable and understandable, even in the presence of complex integrity findings. The AI models are constrained by fine-tuning, versioned prompts and aligned to a policy-defined schema, producing results that are stable, interpretable, and directly attributable to underlying evidence. This approach avoids the opacity associated with many black-box AI systems and ensures that compliance officers, auditors, and regulators can evaluate not just the outcome, but the rationale behind it.

Accordingly, the disclosed system provides not only technical robustness but also legal and operational readiness for deployment in heavily regulated, mission-critical industrial environments. It enables operators to bridge the historical gap between the existence of a backup and the ability to prove its integrity, functionality, and compliance in a manner that is repeatable, auditable, and safe by default.

### Detailed Description of Figures

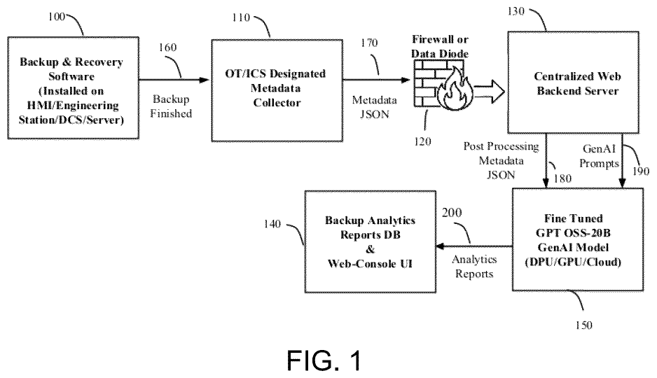

FIG. 1 illustrates a system architecture for post-backup metadata extraction and GenAI-based analysis. A backup and recovery software (100), installed on an HMI, engineering station, DCS, or server, generates backup data, when the backup finished (160) it activates the OT/ICS metadata collector (110). The collector emits structured metadata (170), which passes through a firewall or data diode (120) and is received by a centralized backend server (130). The backend performs post-processing (180) and generates GenAI prompts (190) for a fine-tuned GPT OSS-20B model (150) executing on a DPU, GPU, or cloud resource. The model produces analytics reports (200), which are stored and visualized in a backup analytics reports database and UI (140).

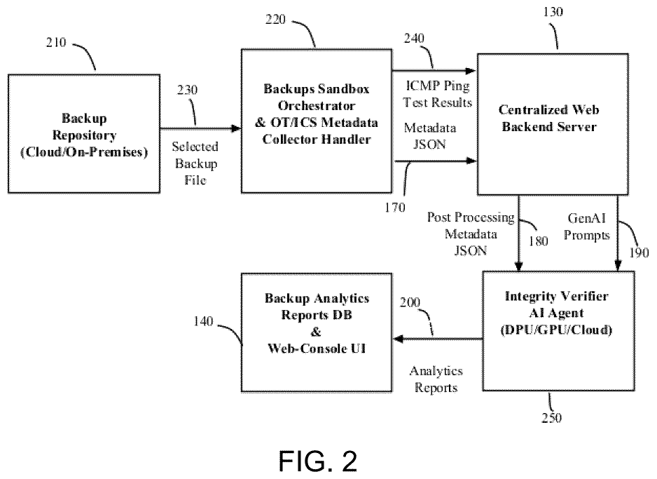

FIG. 2 depicts the architecture of a sandboxed backup verification environment. A selected backup file (230) is retrieved from a backup repository (210) and instantiated by a sandbox orchestrator and metadata collector handler (220). During sandbox execution, telemetry is captured and transformed into metadata JSON (170). An ICMP ping test (240) may verify system boot. All data flows to the centralized backend server (130), where metadata is normalized (180), GenAI prompts (190) are generated, and the integrity verifier AI agent (250) performs risk analysis. Final reports (200) are made available through the UI (140).

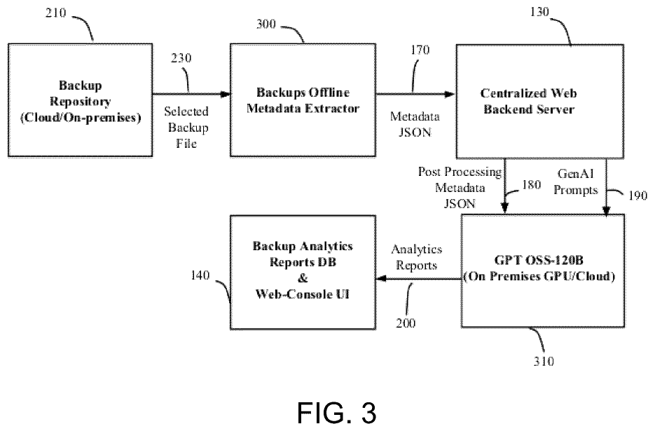

FIG. 3 illustrates an offline analysis pipeline for backup metadata. A selected backup file (230) is read from a backup repository (210) and processed by an offline extractor module (300), which parses static metadata such as filesystem structures and properties, registry hives, and OS event logs. The metadata JSON (170) is sent to the backend server (130) for normalization (180) and GenAI prompt generation (190). A GPT OSS-120B model (310), running on-premises or in a cloud GPU, performs integrity analysis and produces analytics reports (200), which are visualized in the reporting console UI (140).

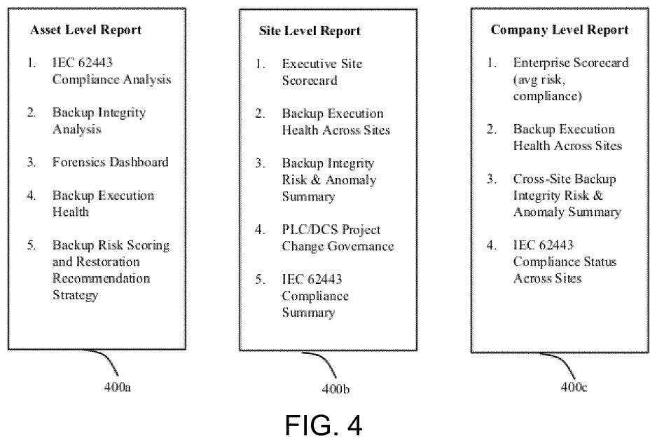

FIG. 4 presents hierarchical compliance and risk reporting artifacts at three levels: (i) an asset-level report (400a) containing IEC 62443 compliance mapping, backup integrity scoring, forensics, and restoration guidance; (ii) a site-level report (400b) showing site scorecards, job health, anomaly summaries, and PLC/DCS project diffs; and (iii) a company-level report (400c) aggregating risk, compliance, and integrity indicators across multiple sites, with support for enterprise-level KPIs and gap detection.

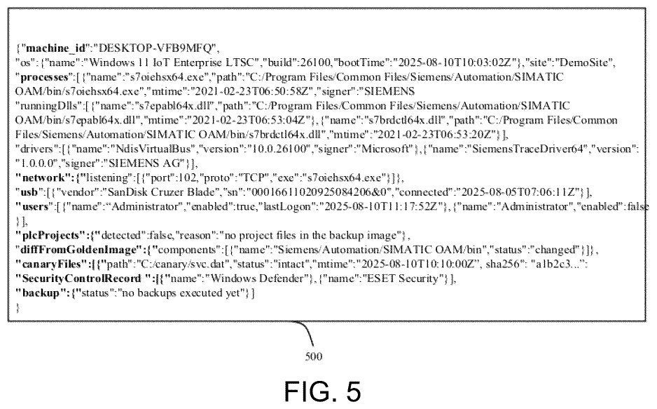

FIG. 5 shows an example of a structured metadata JSON (500) collected from an OT/ICS machine. The record includes fields such as machine ID, operating system version, processes, running DLLs, drivers, network listeners, USB device events, user accounts, PLC project tracker status, diffs from a golden image, canary file status, security control records related to active AV/EDR, and backup execution metadata. This representation provides a complete snapshot of the backup metadata at the time of collection.

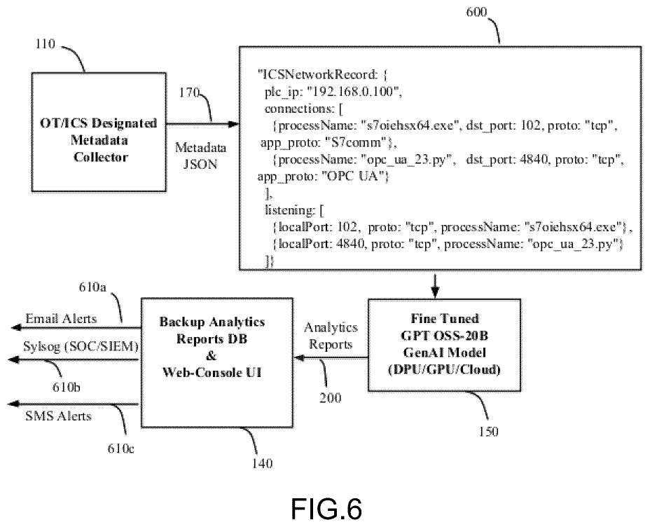

FIG. 6 depicts detection of potentially unauthorized PLC interaction by analyzing ICS network metadata. A metadata collector (110) observes communication traces (600) showing Python and executable processes (e.g., opc_ua_23.py, s7oiehsx64.exe) initiating connections to PLC ports (e.g., S7comm, OPC UA). This data is passed to the GPT OSS-20B GenAI model (150), which analyzes the metadata (170) and produces an integrity report (200). Alerts are triggered through email (610a), syslog/SIEM (610b), or SMS (610c), with report visualization via UI (140).

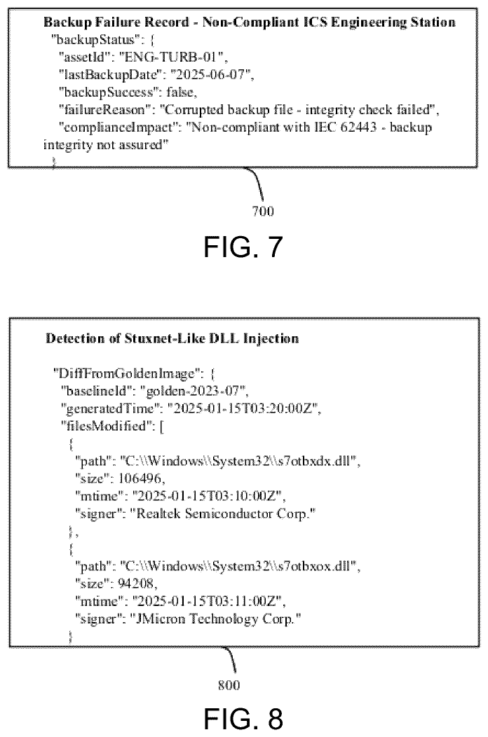

FIG. 7 displays a backup failure record (700) for an ICS engineering station identified as “ENG-TURB-01.” The metadata includes asset ID, timestamp of the last backup attempt, failure reason (“Corrupted backup file-integrity check failed”), and a compliance impact field indicating the backup is non-compliant with IEC 62443 due to unverifiable integrity. This record highlights the system's ability to detect and escalate backup failures with regulatory context.

FIG. 8 shows an example of Stuxnet-style DLL injection detected through golden image differencing. The DiffFromGoldenImage object (800) highlights suspicious DLLs (e.g., s7otbxdx.dll, s7otbxox.dll) residing in the Windows System32 directory and signed by anomalous vendors such as Realtek and JMicron. These changes are used to elevate the backup's risk score and may trigger sandbox detonation or recommendation for recovery rollback from a last known good snapshot.

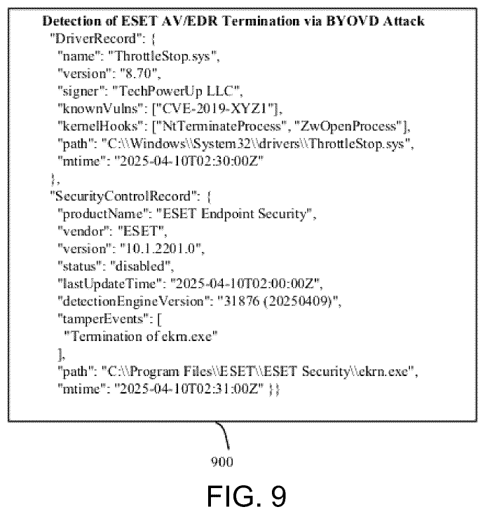

FIG. 9 illustrates a metadata record (900) indicating termination of endpoint security via a Bring Your Own Vulnerable Driver (BYOVD) technique. A vulnerable driver (ThrottleStop.sys) was loaded with kernel hooks (NtTerminateProcess, ZwOpenProcess) and is linked to a security control record showing that ESET Endpoint Security was forcibly disabled. The event is logged with metadata from both driver and security records, contributing to an elevated integrity risk classification for the backup.

What is claimed is:

1. A system for validating the integrity of backup data in operational technology (OT) and industrial control system (ICS) environments, comprising:
a. a metadata collector configured to extract operational and security-relevant metadata from a backup image associated with an OT or ICS asset;
b. a normalization module configured to convert said metadata into a canonical schema comprising at least one of: file system records, driver inventories, registry or initialization data, PLC or DCS project files, service configurations, or runtime telemetry;
c. c. a PLC/DCS project tracker configured to parse PLC/DCS project files, detect deltas in control logic and configuration, and write per-backup annotations as part of said metadata;
d. a generative artificial intelligence (GenAI) engine operable to ingest said normalized metadata, including the annotations produced by the PLC/DCS project tracker, and compute an integrity risk score by comparison to a golden-image baseline; and an output module configured to generate a structured, tamper-evident integrity report comprising said risk score, system deltas, and compliance-relevant indicators.

2. The system of claim 1, wherein the metadata collector operates in a nonintrusive mode that executes only within said sandboxed virtual machine, without any persistent installation on the production asset.

3. The system of claim 1, wherein the metadata collector operates in an intrusive mode on a production host after completion of a backup, and subsequently self-removes according to a policy.

4. The system of claim 1, wherein the sandbox orchestration module modifies the backup image prior to boot by injecting temporary administrative credentials, drivers and a portable collector.

5. The system of claim 1, wherein the GenAI engine is fine-tuned on domain-specific exemplars including OT/ICS cyber attacks selected from the group consisting of: Stuxnet, Industroyer, Triton, Shamoon, and other malware targeting programmable logic controllers.

6. The system of claim 1, wherein the GenAI engine is fine-tuned to parse PLC/DCS project files and exported representations thereof and to detect anomalies in control logic and configuration comprising ladder logic networks, function blocks, Structured Text routines, tag tables, safety interlocks, setpoints, and communication mappings, using one or more parameter-efficient training techniques selected from the group consisting of Low-Rank Adaptation (LoRA), adapter modules, instruction tuning, and prompt tuning, individually or in combination, with optional switching between said techniques based on a detected PLC/DCS family or project format.

7. The system of claim 1, wherein the golden image baseline comprises a canonical, versioned JSON representation of a previously validated system state, and wherein the integrity risk score is derived by computing a difference between said baseline and current backup metadata.

8. The system of claim 1, further comprising a backup scheduling optimization module configured to monitor system activity and recommend low-impact backup windows in accordance with operational constraints.

9. The system of claim 1, wherein said output module generates compliance-ready analytics reports aligned with one or more regulatory frameworks selected from the group consisting of: IEC 62443, NERC CIP, and NIST SP 800-82.

10. The system of claim 1, wherein the sandbox orchestration module performs a recovery test by verifying the virtual machine boots, required services initialize, and ICS applications load correctly.

11. The system of claim 1, further comprising a forensic vault configured to store integrity reports, telemetry artifacts, and AI explanations in a tamper-evident, append-only format.

12. A method for verifying the integrity of a backup in an industrial control system (ICS) environment, comprising the steps of:
a. collecting metadata from a backup image representing an ICS asset;
b. normalizing said metadata into a canonical structure;
c. comparing said metadata to a golden image baseline to identify unauthorized changes;
d. executing said backup image in a sandboxed virtual machine;
e. observing runtime behaviors including process execution, service initialization, and ICS communication patterns;
f. generating an integrity risk score based on both static and dynamic analysis;
g. and outputting a signed report comprising restoration recommendations and regulatory compliance indicators.

13. The method of claim 11, further comprising the step of initiating multiengine threat intelligence analysis by submitting selected file hashes or metadata artifacts to a third-party scanning engine.

14. The method of claim 11, wherein the GenAI engine is instantiated on a SmartNIC data processing unit (DPU) that is fully isolated from the host operating system.

15. The method of claim 11, further comprising flagging backups as non-compliant if no successful recovery test has occurred within a defined regulatory time window.

16. The method of claim 11, further comprising assigning a higher integrity risk score when said metadata indicates unauthorized or anomalous changes in PLC/DCS project files, including changes to ladder logic networks, function blocks, Structured Text routines, tag tables, safety interlocks, setpoints, or communication mappings.

17. The method of claim 11, further comprising assigning a higher integrity risk score when the backup image or a sandboxed execution thereof exhibits indicators of attack, including any of: (a) termination or suppression of endpoint or extended detection and response (EDR/XDR) services, including via bring-your-own-vulnerable-driver (BYOVD) techniques; (b) unauthorized code injection into industrial control system processes, including dynamic-link library (DLL) injection; or (c) presence of scripts or binaries, including Python scripts, configured to establish communications with PLC/DCS devices or to issue unauthorized control commands; and generating a corresponding alert within the report.
